(19) United States
(12) Patent Application Publication
(10) Pub. No.: US 2025/0390034 A1
(43) Pub. Date: Dec. 25, 2025

(54) EXPOSURE DEVICE AND IMAGE FORMING DEVICE

(71) Applicant: SHARP KABUSHIKI KAISHA, Sakai City (JP)

(72) Inventor: Takashi HIROTA, Sakai City (JP)

(21) Appl. No.: 19/235,681

(22) Filed: Jun. 12, 2025

(30) Foreign Application Priority Data
Jun. 21, 2024 (JP) 2024-100721

(51) Int. Cl. G03G 15/043; G03G 15/04

(52) U.S. Cl. CPC G03G 15/043; G03G 15/04054; G03G 2215/0409; G03G 2215/0412

(57) ABSTRACT

An image forming device includes a panel member that faces a photoreceptor and includes a plurality of light-emitting elements. An exposure device includes a signal output unit that outputs drive signals having different phases, and a driver that causes each of the plurality of light-emitting elements to emit light individually, based on the drive signals. In the panel member, element arrays including the plurality of light-emitting elements arranged in a main scanning direction are arranged in a plurality of stages arranged in a sub-scanning direction. The signal output unit outputs the drive signals having a phase difference to the element arrays, respectively. A distance in the sub-scanning direction between the element arrays adjacent to each other is set based on a phase correction value obtained by multiplying a circumferential speed of the front surface of the photoreceptor by the phase difference.

### INCORPORATION OF APPLICATION/PRIORITY

This application claims priority based on Japanese Patent Application No. 2024-100721 filed in Japan on June 21, 2024. By referring to this, all contents thereof are incorporated into this application.

### BACKGROUND ART

### TECHNICAL FIELD

The disclosure relates to an exposure device provided with a panel member including a plurality of light-emitting elements, and to an image forming device.

### Related Art

In the related art, an electrophotographic image forming device is widely used in which an electrostatic latent image is formed on a photoreceptor using a laser beam or the like, and an image is formed on a sheet by performing steps of developing, transferring, and fixing the electrostatic latent image. In recent years, as a light source for exposing the photoreceptor, a linear light source is used in some cases in which point light sources such as light-emitting elements are linearly arrayed. Further, a plurality of light-emitting elements are arrayed not only in a main scanning direction but also in a sub-scanning direction in order to increase the pixel density while increasing the exposure amount. It is known that, when the plurality of light-emitting elements are caused to emit light simultaneously in this manner, an inrush current (change) to a drive circuit increases. Thus, techniques for reducing the load of the current change are proposed.

A known image forming device includes a light-emitting element array that includes a plurality of light-emitting elements continuously arranged along a main scanning direction, a light-emission controller that causes drive signals having different phases to be output, based on image data, in units of light-emitting element groups each constituted by a predetermined number of continuous light-emitting elements included in the plurality of light-emitting elements, and a driver that causes each of the plurality of light-emitting elements to emit light individually, based on the drive signals.

In the known image forming device, since there are phase differences based on the drive signals between the light-emitting element groups, there is a problem in that steps are generated between the light-emitting element groups in a sub-scanning direction. When the generation of the steps is not prevented, image quality deteriorates, and there is a problem in that the number of light-emitting element groups or the phase difference becomes restricted.

The disclosure has been made to solve the above-described problems, and an object of the disclosure is to provide an exposure device and an image forming device that are capable of preventing a step from being generated in an image.

### SUMMARY

An exposure device according to the disclosure includes a panel member facing a photoreceptor and including a plurality of light-emitting elements. The exposure device includes a signal output unit outputting drive signals having different phases, and a driver causing each of the plurality of light-emitting elements to emit light individually, based on the drive signals. When a direction along a rotation axis of the photoreceptor is a main scanning direction and a direction orthogonal to the main scanning direction is a sub-scanning direction, in the panel member, element arrays including the plurality of light-emitting elements arranged along the main scanning direction are arranged in a plurality of stages arranged in the sub-scanning direction. The signal output unit outputs the drive signals having a phase difference to the element arrays, respectively, and a distance in the sub-scanning direction between the element arrays adjacent to each other is set based on a phase correction value obtained by multiplying a circumferential speed of a front surface of the photoreceptor by the phase difference.

In the exposure device according to the disclosure, the plurality of light-emitting elements of the element arrays may be divided into a plurality of groups, and the signal output unit may output the drive signals having the phase difference to the plurality of groups, respectively.

In the exposure device according to the disclosure, when the circumferential speed of the front surface of the photoreceptor changes, the signal output unit may adjust the phase of the drive signal to maintain the phase correction value at a constant value.

In the exposure device according to the disclosure, the distance in the sub-scanning direction between the element arrays adjacent to each other may be a value obtained by adding the phase correction value to an integer multiple of a pixel size in the sub-scanning direction.

An image forming device according to the disclosure includes the exposure device according to the disclosure.

According to the disclosure, by dividing, of the light-emitting elements, element groups to be caused to emit light into stages, appropriately setting the distance between the stages, and performing control so as to cause the light-emitting elements of the element groups to emit light at appropriate timings, it is possible to obtain a necessary exposure amount while suppressing an inrush current, and to avoid a deterioration in image quality by preventing generation of a step in an image.

### BRIEF DESCRIPTION OF DRAWINGS

FIG. 1 is a schematic cross-sectional view illustrating an image forming device according to a first embodiment of the disclosure.

FIG. 2 is a schematic diagram illustrating a configuration of the image forming device according to the first embodiment of the disclosure.

FIG. 3 is a schematic plan view illustrating a panel member according to the first embodiment of the disclosure.

FIG. 4 is a timing chart showing light-emission timings of light-emitting elements.

FIG. 5 is an explanatory diagram illustrating an example of an image exposed in a reference example.

FIG. 6 is an explanatory diagram illustrating an example of an image exposed in the first embodiment of the disclosure.

FIG. 7 is a schematic plan view illustrating the panel member according to a second embodiment of the disclosure.

### DESCRIPTION OF PREFERRED EXAMPLES

### First Embodiment

An image forming device according to a first embodiment of the disclosure will be described below with reference to the accompanying drawings.

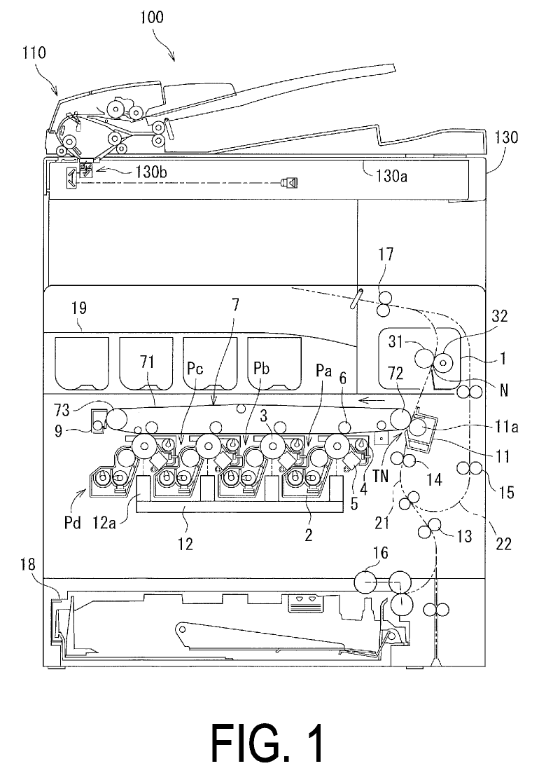

FIG. 1 is a schematic cross-sectional view illustrating an image forming device according to the first embodiment of the disclosure.

An image forming device 100 is a multi-function printer that has a copy function, a scanner function, a facsimile function, and a printer function. The image forming device 100 transmits an image of a document read by an image reader 130 to an external device, or forms an image of a document read by the image reader 130 or an image received from the external device, on a recording medium such as a sheet in color or monochrome.

A document feeding device 110 supported in an openable/closable manner is provided on the upper side of the image reader 130. The document feeding device 110 feeds one or a plurality of the documents one at a time. The image reader 130 generates image data by causing a scanning optical system 130b to scan a document placed on a document table 130a to read the document, or by reading a document fed by the document feeding device 110.

The image forming device 100 includes a fixing device 1, a development device 2, a photoreceptor drum 3 (an example of a photoreceptor), a drum cleaning device 4, a charger 5, an intermediate transfer belt device 7, a secondary transfer device 11, an exposure device 12, a sheet feeder 18, and the like.

The image forming device 100 handles image data corresponding to a color image composed of the colors black (K), cyan (C), magenta (M), and yellow (Y), or a monochrome image composed of a single color (black, for example). The image forming device 100 is provided with four of the development devices 2, four of the photoreceptor drums 3, four of the drum cleaning devices 4, and four of the chargers 5 that form four types of toner images and respectively serve as four image stations Pa, Pb, Pc, Pd corresponding to the colors black, cyan, magenta, and yellow, respectively.

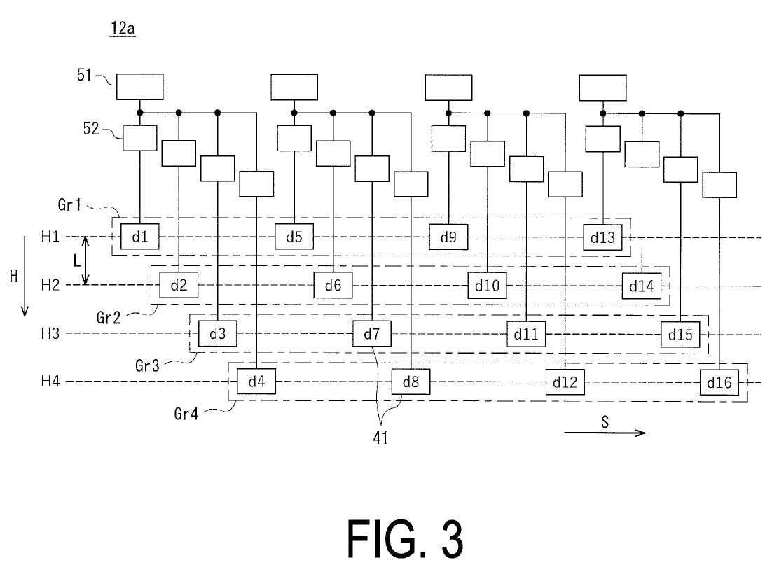

The charger 5 uniformly charges the front surface of the photoreceptor drum 3 to a predetermined potential. The exposure device 12 includes a panel member 12a facing the front surface of the photoreceptor drum 3, and forms an electrostatic latent image by exposing the front surface of the photoreceptor drum 3. The development device 2 develops the electrostatic latent image on the front surface of the photoreceptor drum 3 to form a toner image on the surface of the photoreceptor drum 3. The drum cleaning device 4 removes and collects residual toner on the front surface of the photoreceptor drum 3. With the series of operations described above, the toner images of the respective colors are formed on the front surfaces of the respective photoreceptor drums 3. Note that the distance between the photosensitive drum 3 and the panel member 12a may be appropriately set in accordance with the resolution of the electrostatic latent image and the light amount of the panel member 12a. The panel member 12a will be described in detail below with reference to FIG. 3.

The intermediate transfer belt device 7 includes intermediate transfer rollers 6, an intermediate transfer belt 71 having an endless shape, an intermediate transfer driving roller 72, an intermediate transfer driven roller 73, and a cleaning device 9. Four of the intermediate transfer rollers 6 are provided on the inner side of the intermediate transfer belt 71 to form the four types of toner images corresponding to the respective colors. The intermediate transfer rollers 6 transfer the toner images of the respective colors formed on the front surfaces of the photoreceptor drums 3, to the intermediate transfer belt 71 that is moving in a circularly rotating manner.

The intermediate transfer belt 71 is stretched over the intermediate transfer driving roller 72 and the intermediate transfer driven roller 73. In the image forming device 100, the toner images of the respective colors formed on the front surfaces of the respective photoreceptor drums 3 are sequentially transferred and superimposed on the front surface of the intermediate transfer belt 71 to form a color toner image. The cleaning device 9 removes and collects waste toner that did not transfer to the sheet and remains on the front surface of the intermediate transfer belt 71.

In the secondary transfer device 11, a sheet conveyed along a sheet conveying path 21 is conveyed while being nipped at a transfer nip portion TN between a secondary transfer roller 11a and the intermediate transfer belt 71. When the sheet passes through the transfer nip portion TN, the toner image on the front surface of the intermediate transfer belt 71 is transferred onto the sheet, and the sheet is conveyed to the fixing device 1.

The fixing device 1 includes a fixing belt 31 and a pressure roller 32 that rotate around an axis. In the fixing device 1, the sheet with the transferred toner image is nipped by a nip portion N between the fixing belt 31 and the pressure roller 32 and subjected to heat and pressure to fix the toner image onto the sheet. Although not illustrated in FIG. 1, the fixing device 1 may also include components other than the fixing belt 31 and the pressure roller 32.

The sheet feeder 18 includes a sheet feeding cassette that stores recording media (sheets) to be used for image formation, and is provided below the exposure device 12. The sheet is pulled out from the sheet feeder 18 by pickup rollers 16, and conveyed to the sheet conveying path 21. The sheet conveyed to the sheet conveying path 21 is discharged to a discharge tray 19 by discharge rollers 17 via the secondary transfer device 11 and the fixing device 1.

Conveying rollers 13, registration rollers 14, and the discharge rollers 17 are disposed along the sheet conveying path 21. The conveying rollers 13 facilitate the conveyance of the sheet. The registration rollers 14 convey the sheet at a speed equal to a process speed at which an image is formed on the sheet. The registration rollers 14 are provided between the sheet feeder 18 and the secondary transfer device 11, and adjust a conveyance timing of the sheet so that the toner image is transferred to the sheet in the secondary transfer device 11. For example, the registration rollers 14 are caused to wait (temporarily stop) in a state in which the sheet fed from the sheet feeder 18 is nipped therebetween, and are then caused to start conveying the sheet at a constant speed in synchronization with the secondary transfer device 11.

When images are formed on both the front surface and the back surface of the sheet, a conveyance direction of the sheet is changed by the discharge rollers 17, and the sheet is conveyed to a reverse conveying path 22. In the reverse conveying path 22, the front and back sides of the sheet are reversed by reverse conveying rollers 15, and the sheet is guided to the registration rollers 14 in that state. The image forming device 100 forms the image on the back surface of the sheet guided to the registration rollers 14 in a similar manner to the case of forming the image on the front surface of the sheet, and then discharges the sheet to the discharge tray 19.

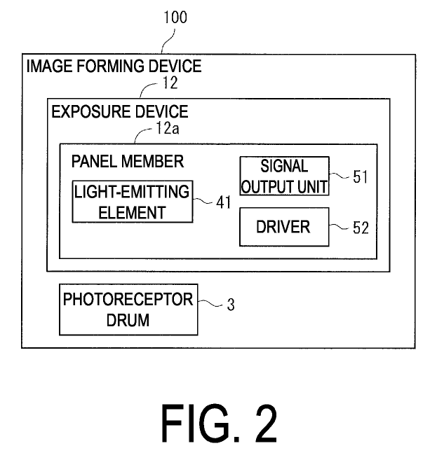

FIG. 2 is a schematic diagram illustrating a configuration of the image forming device according to the first embodiment of the disclosure. Note that, in FIG. 2, a part of the image forming device 100 is extracted and illustrated, and the image forming device 100 may include other members not illustrated in FIG. 2 as appropriate.

The panel member 12a includes a plurality of light-emitting elements 41. The light-emitting element 41 is, for example, an organic electroluminescence diode (OLED), an LED, or the like. A signal output unit 51 outputs a plurality of drive signals having different phases from one another. A driver 52 is, for example, a drive circuit, and causes each of the plurality of light-emitting elements 41 to emit light individually, based on the drive signals. The image forming device 100 may be equipped with a CPU that controls the operation of each unit.

FIG. 3 is a schematic diagram illustrating a configuration of the panel member according to the first embodiment of the disclosure.

In the exposure device 12, four of the panel members 12a are provided so as to face the four photosensitive drums 3, respectively. Note that the exposure device 12 may be provided independently for each of the photosensitive drums 3, and it is sufficient that the panel members 12a are provided corresponding to each of the four photosensitive drums 3. Since the four panel members 12a each have substantially the same configuration, one of the panel members 12a is extracted and schematically illustrated in FIG. 3. Although not illustrated, an optical member such as a lens may be disposed between the photosensitive drum 3 and the panel member 12a so that light emitted from the light-emitting element 41 forms an image on the front surface of the photosensitive drum 3. In addition, a spacer or the like may be provided so as to maintain a constant distance between the photosensitive drum 3 and the panel member 12a.

In the image forming device 100, an axial direction along a rotation axis of the photosensitive drum 3 is parallel to a width direction of the sheet on which an image is formed, and the photosensitive drum 3 rotates around the rotation axis. The panel member 12a is a rectangular flat plate, the longitudinal direction (main scanning direction S) of the panel member 12a corresponds to the axial direction, and the lateral direction (sub-scanning direction H) of the panel member 12a corresponds to a rotation direction of the photosensitive drum 3.

In the panel member 12a, element arrays (first group Gr1 to fourth group Gr4), each including a plurality of the light-emitting elements 41 arranged in the main scanning direction S, are arranged in a plurality of stages arranged in the sub-scanning direction H. Hereinafter, in order to distinguish the plurality of light-emitting elements 41 from one another, the light-emitting elements 41 may be referred to by numbers d1, d2, ···, d16 in order from one end side (left end side in FIG. 3) to another end side (right end side in FIG. 3) in the main scanning direction S.

In the present embodiment, a plurality of the light-emitting elements 41 arranged obliquely with respect to the main scanning direction S are regarded as one set, and a configuration is adopted in which these sets are periodically and repeatedly arranged. Specifically, the plurality of light-emitting elements 41 constituting the one set are arranged such that, with respect to the light-emitting elements 41 that are adjacent thereto in the main scanning direction S, positions thereof in the sub-scanning direction H are displaced from each other from one end (upper end in FIG. 3) to another end (lower end in FIG. 3), in one direction along the main scanning direction S. Then, the plurality of light-emitting elements 41 constituting the next set are arranged once again so that positions thereof are arranged in order from the one end side in the sub-scanning direction H. Broken lines H1 to H4 (first to fourth lines) illustrated in FIG. 3 are parallel to the main scanning direction S, are arranged at regular intervals in the sub-scanning direction H, and indicate the positions in the sub-scanning direction H. That is, the light-emitting elements 41 arranged on the same line overlap each other in position in the sub-scanning direction H.

In the panel member 12a illustrated in FIG. 3, the light-emitting element 41 of d1 is arranged on a first line (H1) located on the uppermost end side in FIG. 3, the light-emitting element 41 of d2 is arranged on a second line (H2) displaced to the lower end side from the first line, the light-emitting element 41 of d3 is arranged on a third line (H3) displaced to the lower end side from the second line, and the light-emitting element 41 of d4 is arranged on a fourth line (H4) displaced to the lower end side from the third line. Similarly, the light-emitting elements 41 of d3 and thereafter are arranged to be sequentially displaced to the lower end side, and the light-emitting element 41 of d8 is arranged on the fourth line (H4) located on the lowermost end side in FIG. 3.

The light-emitting elements 41 of d5 to d8 repeat the same arrangement as that of the light-emitting elements 41 of d1 to d4, and the light-emitting element 41 of d5 is arranged on the first line. The light-emitting elements 41 of d6 and thereafter are sequentially displaced to the lower end side, and the light-emitting element 41 of d8 is arranged on the fourth line. The light-emitting elements 41 of d9 to d12 and the light-emitting elements 41 of d13 to d16 are arranged in the same manner as the light-emitting elements 41 of d1 to d4.

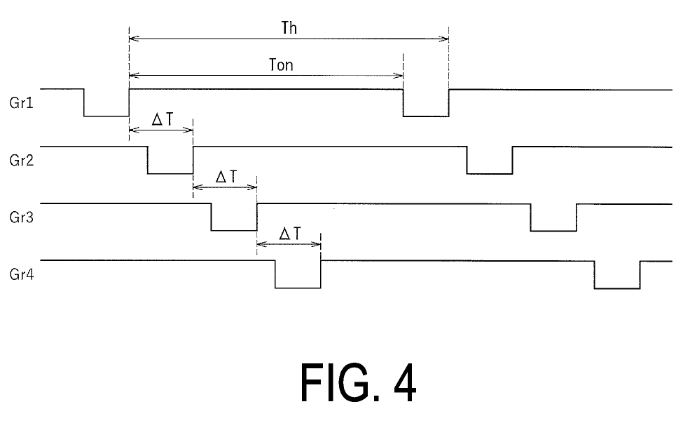

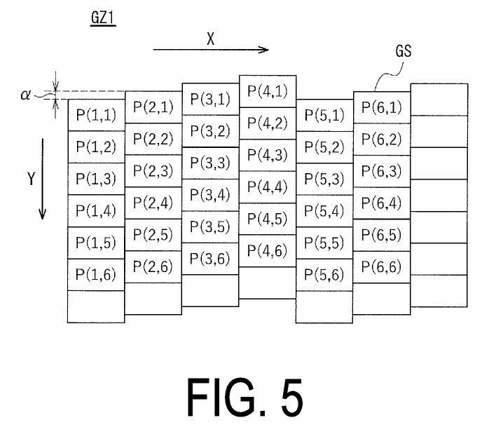

That is, the light-emitting elements 41 of d1, d5, d9, and d13 form a first group Gr1 arranged on the same first line, the light-emitting elements 41 of d2, d6, d10, and d14 form a second group Gr2 arranged on the same second line, the light-emitting elements 41 of d3, d7, d11, and d15 form a third group Gr3 arranged on the same third line, and the light-emitting elements 41 of d4, d8, d12, and d16 form a fourth group Gr4 arranged on the same fourth line. The interval (step pitch L) between the lines adjacent to each other corresponds to the distance between the element arrays adjacent to each other in the sub-scanning direction H. The step pitch L will be described below with reference to FIGS. 4 and 5.

As illustrated in FIG. 3, the driver 52 is provided corresponding to each of the light-emitting elements 41, and the signal output unit 51 is provided corresponding to a plurality of the drivers 52. In the configuration illustrated in FIG. 3, sixteen of the drivers 52 and four of the signal output units 51 are provided. Specifically, one of the signal output units 51 is provided for four of the drivers 52 corresponding to the light-emitting elements 41 of d1 to d4. Similarly, one of the signal output units 51 is provided for each of four of the drivers 52 corresponding to the light-emitting elements 41 of d5 to d8, four of the drivers 52 corresponding to the light-emitting elements 41 of d9 to d12, and four of the drivers 52 corresponding to the light-emitting elements 41 of d13 to d16. Note that the configuration illustrated in FIG. 3 is an example of the panel member 12a, and the numbers of the signal output units 51 and the drivers 52 to be provided and a method of connecting the signal output unit 51 and the driver 52 to each of the light-emitting elements 41 may be changed as appropriate.

Although not illustrated, a switch or the like for switching between ON and OFF may be connected to the light-emitting element 41, and a signal line or the like for transmitting a signal for controlling the switch or the like may be connected to each unit. Further, the light-emitting element 41 may not only be switched between ON and OFF but the light amount or the light-emission time period thereof may also be changed by changing the voltage, the current, or the like. In this case, the light-emitting element 41 may be appropriately controlled by a signal input to the driver 52.

As described above, in the present embodiment, the group is constituted for each of the element arrays, and the first group Gr1 to the fourth group Gr4 are provided. Then, the signal output unit 51 outputs the drive signals having the phase difference to the respective element arrays. Next, the relationship between the drive signal output to each of the groups and the operation of each of the groups will be described with reference to FIG. 4.

FIG. 4 is a timing chart showing light-emission timings of the light-emitting elements.

In FIG. 4, the drive signals output to the first group Gr1 to the fourth group Gr4 are illustrated in order from the top. A light-emission time period Ton indicates a time period during which the light-emitting elements 41 of each of the groups emit light (are turned on), and each of the drive signals is set to be turned on for a time period corresponding to one pixel and then turned off. A line cycle Th is a line cycle of a horizontal synchronization signal. The line cycle Th corresponds to a time period for one line, and corresponds to a time period over which the light-emitting element 41 is turned off after being turned on, and is then once more turned on. A phase difference ΔT indicates a phase shift of the drive signal between the groups adjacent to each other.

In the present embodiment, the first group Gr1, the second group Gr2, the third group Gr3, and the fourth group Gr4 are set to emit light in this order with a time difference therebetween. That is, after the first group Gr1 is turned on, when a time period corresponding to the phase difference ΔT elapses, the second group Gr2 is turned on. Thereafter, similarly, the third group Gr3 and the fourth group Gr4 are sequentially turned on at the respective timings at which the time period corresponding to the phase difference ΔT elapses. In this way, by providing the time difference (phase difference ΔT) between light-emission start and end timings of the light-emitting elements 41 included in each of the groups, it is possible to suppress an instantaneous increase in current fluctuation.

In the exposure device 12, the product of the phase difference ΔT and a number n of the groups (four in the present embodiment) is preferably set to satisfy the relationship "Th > ΔT × n" so that the light-emission start timings of the light-emitting elements 41 included in all the groups fall within the time period of the line cycle Th.

Incidentally, when the phase difference ΔT is provided to shift the light-emission timing for each of the groups, there is a problem in that steps are generated in an exposed image. Next, steps in an image will be described with reference to FIG. 5.

FIG. 5 is an explanatory diagram illustrating an example of an image exposed in a reference example.

In the image forming device 100, vertical and horizontal coordinates are set for each of pixels GS of an image to be formed. A horizontal direction X is the width direction of the sheet and corresponds to the axial direction (main scanning direction S) of the photosensitive drum 3. A vertical direction Y is a longitudinal direction of the sheet and corresponds to the rotation direction (sub-scanning direction H) of the photosensitive drum 3.

In the following description, a coordinate in the horizontal direction X may be abbreviated as Xn (n is a natural number), and a coordinate in the vertical direction Y may be abbreviated as Ym (m is a natural number). For example, X1 is a coordinate corresponding to the light-emitting element 41 of d1, and X2 is a coordinate corresponding to the light-emitting element 41 of d2. Further, Y1 is a coordinate corresponding to the pixel GS located at the top in the vertical direction Y, and Y2 is a coordinate corresponding to the pixel GS located one row below Y1. In FIG. 5, a part of an image (first image GZ1) formed in the reference example is extracted and illustrated, and coordinates P of each of the pixels GS may be abbreviated as "P(Xn,Ym)".

In the reference example, the step pitch L is an integer multiple of a pixel size (D) in the sub-scanning direction H. When the photosensitive drum 3 rotates in the sub-scanning direction H at a circumferential speed V, the product of the line cycle Th and the circumferential speed V is equal to the pixel size in the sub-scanning direction H and is set to satisfy the relationship "Th × V = D". At this time, since the phase difference ΔT is provided between the light-emission timings of the pixels GS adjacent to each other in the horizontal direction X, for example, a step α in the vertical direction Y is generated between P(1,1) and P(2,1). Here, the step α is based on the circumferential speed V and the phase difference ΔT, and corresponds to a value of "ΔT × V". Further, the step becomes larger as the pixel GS is displaced further in the horizontal direction X, and when the pixels GS having the largest phase difference ΔT therebetween, for example, P(4,1) and P (5,1) are compared, the step is "3 × α".

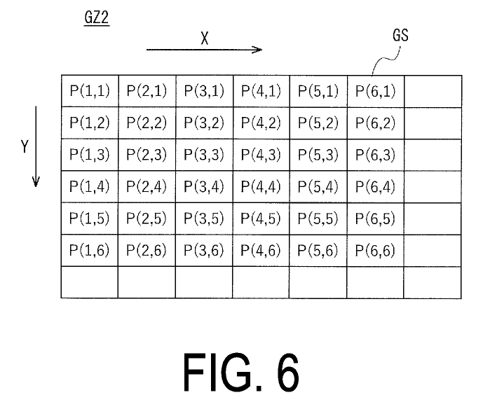

In contrast, in the present embodiment, the step pitch L is appropriately set so that no step is generated in the exposed image. Next, an image in which the generation of the steps is prevented will be described with reference to FIG. 6.

FIG. 6 is an explanatory diagram illustrating an example of an image exposed in the first embodiment of the disclosure.

In FIG. 6, similarly to FIG. 5, a part of an image (second image GZ2) formed in the present embodiment is extracted and illustrated. In the present embodiment, the step pitch L is corrected based on a phase correction value obtained by multiplying the circumferential speed V by the phase difference ΔT. Specifically, the step pitch L is set to a value obtained by adding the phase correction value to an integer multiple of the pixel size in the sub-scanning direction H. The phase correction value is set to the same value (ΔT × V) as that of the step α generated in the reference example, and the step pitch L is expressed by the equation "L = D + α".

By correcting the value of the step pitch L based on the phase correction value, the step α is eliminated. As a result, in the second image GZ2, the pixels GS are neatly arranged in a lattice pattern. In this way, by dividing, of the light-emitting elements 41, element groups to be caused to emit light into stages, appropriately setting the distance between the stages, and performing control so as to cause the light-emitting elements 41 of the element groups to emit light at appropriate timings, it is possible to obtain a necessary exposure amount while suppressing the inrush current and to avoid a deterioration in image quality by preventing the generation of the steps in the image. Further, by using the size of the pixel GS exposed by the light-emitting element 41 as a reference, and performing correction based on the phase correction value, it is possible to appropriately set the distance between the element arrays.

In the present embodiment, a configuration has been described in which a distance of about one pixel is provided between the element arrays. However, the configuration is not limited to this example, and a configuration may be adopted in which a distance of a plurality of the pixels is provided between the element arrays. In this case, the step pitch L may be set so as to satisfy the relationship "L = D × k + α" (k is a natural number).

Further, when the circumferential speed of the photosensitive drum 3 changes, the signal output unit 51 may adjust the phase of the drive signal so as to maintain the phase correction value at a constant value. In this way, by making the adjustment so as not to change the phase correction value, even when the circumferential speed of the photosensitive drum 3 changes, it is possible to cope with the change so that the steps are not generated in the image.

### Second Embodiment

Next, an image forming device according to a second embodiment of the disclosure will be described with reference to the accompanying drawings. The second embodiment differs from the first embodiment in terms of the configuration of the group. Note that since the second embodiment has a configuration substantially similar to that of the first embodiment illustrated in FIG. 1 to FIG. 6, description thereof will be omitted and only different points will be described.

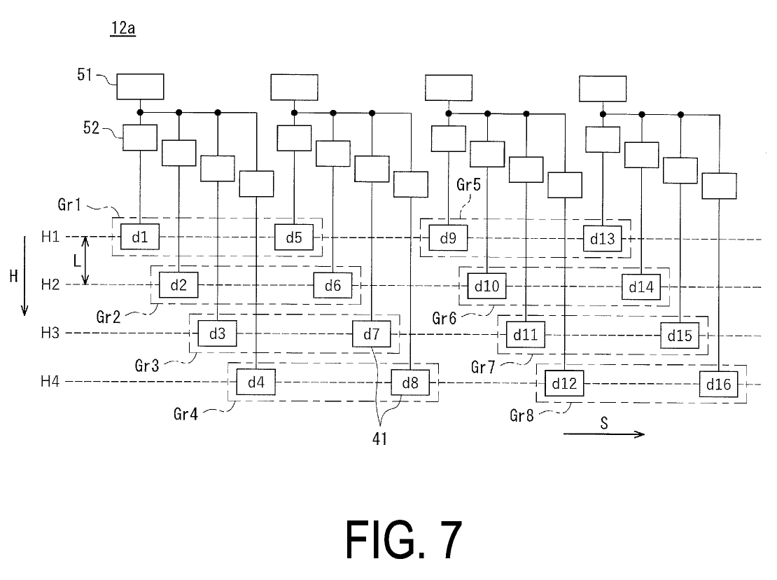

FIG. 7 is a schematic plan view illustrating the panel member according to the second embodiment of the disclosure.

In FIG. 7, similarly to FIG. 6, one of the panel members 12a is extracted and schematically illustrated. In the second embodiment, the arrangement of the light-emitting elements 41 is the same as that in the first embodiment, but a method of grouping the light-emitting elements 41 is different. Specifically, the light-emitting elements 41 of d1 and d5 constitute the first group Gr1 on the first line, the light-emitting elements 41 of d2 and d6 constitute the second group Gr2 on the second line, the light-emitting elements 41 of d3 and d7 constitute the third group Gr3 on the third line, and the light-emitting elements 41 of d4 and d8 constitute the fourth group Gr4 on the fourth line. Then, the light-emitting elements 41 of d9 and d13 constitute a fifth group Gr5 on the first line, the light-emitting elements 41 of d10 and d14 constitute a sixth group Gr6 on the second line, the light-emitting elements 41 of d11 and d15 constitute a seventh group Gr7 on the third line, and the light-emitting elements 41 of d12 and d16 constitute an eighth group Gr8 on the fourth line.

That is, even the light-emitting elements included in the element array arranged on the same line are divided into a plurality of groups, for example, into the first group Gr1 and the fifth group Gr5. In this way, by not only dividing the element groups to be caused to emit light into stages but also dividing the light-emitting elements into the plurality of groups even within the element array, it is possible to finely set divided lighting groups and further reduce the inrush current.

Note that the embodiments disclosed herein are illustrative in all respects and are not the basis for a limited interpretation. Accordingly, the technical scope of the disclosure is not to be construed by the foregoing embodiments only and is defined based on the description of the claims. In addition, meanings equivalent to the range of the claims and all changes made within the range are included.

1. An exposure device that includes a panel member facing a photoreceptor and including a plurality of light-emitting elements, the exposure device comprising:
a signal output unit outputting drive signals having different phases; and
a driver causing each of the plurality of light-emitting elements to emit light individually, based on the drive signals,
wherein when a direction along a rotation axis of the photoreceptor is a main scanning direction and a direction orthogonal to the main scanning direction is a sub-scanning direction,
in the panel member, element arrays including the plurality of light-emitting elements arranged along the main scanning direction are arranged in a plurality of stages arranged in the sub-scanning direction,
the signal output unit outputs the drive signals having a phase difference to the element arrays, respectively, and
a distance in the sub-scanning direction between the element arrays adjacent to each other is set based on a phase correction value obtained by multiplying a circumferential speed of a front surface of the photoreceptor by the phase difference.

2. The exposure device according to claim 1,
wherein the plurality of light-emitting elements of the element arrays are divided into a plurality of groups, and
the signal output unit outputs the drive signals having the phase difference to the plurality of groups, respectively.

3. The exposure device according to claim 1,
wherein, when the circumferential speed of the front surface of the photoreceptor changes, the signal output unit adjusts the phase of the drive signal to maintain the phase correction value at a constant value.

4. The exposure device according to claim 1,
wherein the distance in the sub-scanning direction between the element arrays adjacent to each other is a value obtained by adding the phase correction value to an integer multiple of a pixel size in the sub-scanning direction.

5. An image forming device comprising:
the exposure device according to claim 1.
